(19) United States
(12) Patent Application Publication
(10) Pub. No.: US 2006/0251772 A1
(43) Pub. Date: Nov. 9, 2006

(54) Pressurized baking batter

(76) Inventors: Sean O'Conner, San Francisco, CA (US); Nate Steck, San Francisco, CA (US)

Correspondence Address: FLIESLER MEYER, LLP, FOUR EMBARCADERO CENTER, SUITE 400, SAN FRANCISCO, CA, 94111, US

(21) Appl. No.: 11/123,271

(22) Filed: May 5, 2005

(51) Int. Cl. A23L 1/00

(52) U.S. Cl. 426/116

(57) ABSTRACT

A food product including a bakable batter provided in a pressurized can. Different gases are used to provide different baking products including waffles and pancakes. In the can, gas is combined with a water-mixed dry batter recipe under pressure.

### BACKGROUND OF THE INVENTION

1. Field of the Invention

The present invention is directed to food products, specifically pre-mixed or ready to cook batters and doughs.

2. Description of the Related Art

A number of different types of food products come in a pressurized dispenser, such a can. Perhaps the most well-known example is pressurized whipping cream and the commercial product Cheez Whiz. Cheez Whiz is a thick heavy sauce product made by Kraft Foods and sold in an both a jar and a pressurized can. Other types of pressurized can food products include decorative dessert toppings.

Some of these products have a stable shelf life, meaning they do not require refrigeration during storage, while others, such as whipped cream require refrigeration before and after sale.

Consumers have come to find foods provided in pressurized cans to be convenient to use. Hence, different foods provided in such a manner are advantageous. Typically, dough and batter used in baking comes in dry form or must be assembled from component ingredients from scratch.

### SUMMARY OF THE INVENTION

The present invention, roughly described, pertains to a food product including a bakable batter provided in a pressurized can. Different gases are used to provide different baking products including waffles and pancakes. In the can, gas is combined with a water-mixed dry batter recipe under pressure.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 is a depiction of the food product of the present invention.

FIG. 2 depicts a flowchart for making the product of the present invention.

### DETAILED DESCRIPTION

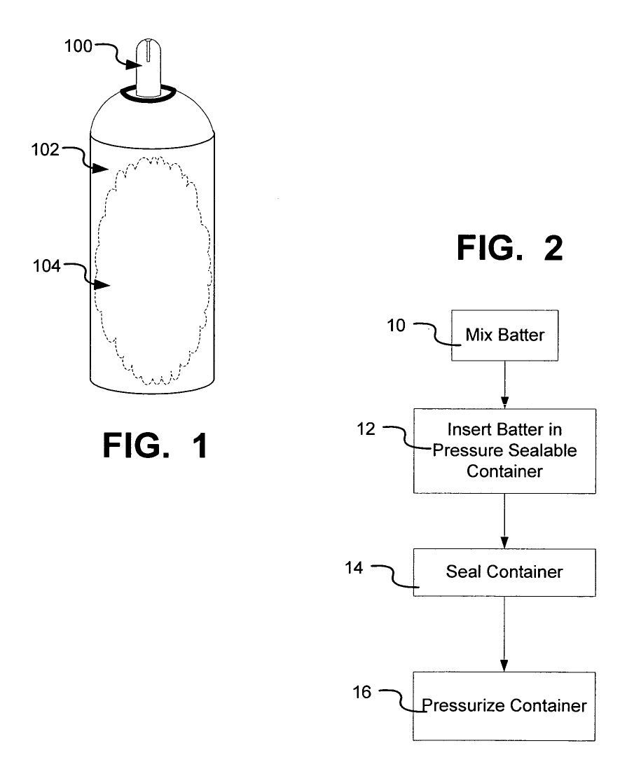

The invention comprises a batter mix such as that which is useful for making pancakes and/or waffles, but which is provided in a pressurized dispenser such as a sealed can. FIG. 1 is a depiction of a dispenser 102 suitable for use in storing and dispensing the batter 104 provided therein. The can is well known in the industry and do consumers alike, and includes a spout 100 which releases pressurized contents 104 when an individual depresses the spout 100 to expend the contents of the can. While the container shown in FIG. 1 is an exemplary embodiment of a dispenser 102, numerous variations on the shape and dispenser are suitable for use with the present invention. The inventors have empirically determined that providing a shelf-stable, bakable batter in a pressurized can, using the specified gas and pressure combinations set forth herein, produces a superior quality baked good when the product is cooked in a manner similar to current dry mix products stored in boxes or bags.

FIG. 2 shows a method for assembling a charged batter-filled food in a pressurized container. Generally, the batter recipe will be mixed at step 10, the batter inserted into a pressurized sealable container at step 12, the container sealed at step 14, and the container pressurized in accordance with well-known techniques at step 16.

The mix recipe can be used to create pancakes (single sided grilling) or waffles (double sided, patterned grilling). The pancake mix utilized for the present invention is a pancake mix is commercially available from Elite Spice Inc., Sparks, Nev. Other dry-mix products, activated by a combination of the mix with water, milk or other fluids, are likewise suitable for use in the present invention.

The ingredients of the mix include wheat flour, sugar, nonfat dry milk, baking powder, including corn starch, sodium aluminum phosphate, sodium bicarbonate, egg solids, shortening powder (partially hydrogenated soybean oil), corn syrup solids, sodium casinate, mono and diglycerides, and sodium silicoaluminate (anti-caking agent), sodium benzonate, salt, and natural butter flavor. This recipe is mixed by adding water to the mixture in an appropriate amount (set forth below) depending on the desired batter product.

The water-to-mix ratio for waffles is 50-50; the water-to-mix ratio for pancakes is 52.5-47.5%. The water in the can is provided with 0.1% potassium sorbate and 0.05% sorbic acid which is 0.15% for the total weight of batter in the can. This controls the yeast, mold, and Ph levels to hold the product shelf stable. The inclusion of these ingredients in the water provides a shelf-stable product, requiring no refrigeration.

The pressurizing step provides with different mixtures of a pressurized gas, depending on the particular application (pancakes or waffles) for the batter in the can. If the batter is to be used as a waffle mix, gas containers are pressurized with carbon dioxide (CO₂) pressurized at 130 pounds per square inch. The weight of the gas is 5.4 grams and the pressure drops to 86 pounds after canning because the pressure causes the CO₂ to dissolve into the mixed batter in the can. For a pancake mix, the gas is nitrogen (N₂) and CO₂ mixed gas in a ratio range of 90% nitrogen-10% carbon dioxide to 80% nitrogen-20% carbon dioxide. The weight of the nitrogen is 3.9 grams and the can is initially pressurized to 130 pounds. The following is the nutritional information for the product: Because only 10-20% of the gas is CO2, the absorption rate for the CO2 is the same, but the N2 will not absorb, and hence the resulting total pressure is higher. This provides a thinner batter more suitable for pancakes.

For Total Weight: 100 g (3.53 oz-wt.) Mixed Pancake Batter:

Nutritional Analysis per 100 g

| | | |
|---|---|---|
| Calories | 170 | cal |
| Fat Calories | 30 | cal |
| Sat Fat Calories | 50 | cal |
| Total Fat | 3 | g |
| Saturated Fat | 6 | g |
| Stearic Acid | 0 | g |
| Trans Fatty Acids | 0.5 | g |
| Polyunsaturated Fat | 0 | g |
| Omega-6 | — | g |
| Omega-3 | — | g |
| Monounsaturated Fat | 1.5 | g |
| Cholesterol | 35 | mg |
| Sodium | 900 | mg |
| Potassium | 80 | mg |
| Total Carbohydrate | 31 | g |
| Dietary Fiber | 4 | g |
| Soluble Fiber | 0 | g |
| Insoluble Fiber | 3 | g |
| Sugars | 8 | g |
| Sugar Alcohol | 0 | g |
| Other Carbohydrate | 0 | g |
| Protein | 6 | g |
| Vitamin A | 0% | DV |
| Vitamin A (RE) | — | RE |
| Vitamin C | 0% | DV |
| Calcium | 25% | DV |
| Iron | 10% | DV |
| Vitamin D | —% | DV |
| Vitamin E | 0% | DV |
| Vitamin K | —% | DV |
| Thiamin | 20% | DV |
| Riboflavin | 0% | DV |
| Niacin | 6% | DV |
| Vitamin B6 | 0% | DV |
| Folate | 0% | DV |
| Vitamin B12 | 0% | DV |
| Biotin | —% | DV |
| Pantothenic Acid | 8% | DV |
| Phosphorus | 20% | DV |
| Iodine | —% | DV |
| Magnesium | 0% | DV |
| Zinc | 0% | DV |
| Selenium | —% | DV |
| Copper | 0% | DV |
| Manganese | —% | DV |
| Chromium | —% | DV |
| Molybdenum | —% | DV |
| Chloride | —% | DV |

The resultant product yields the most fluffy pancakes and waffles yet known to exist by the inventors of the present invention. This is a result of the gas incorporation into the batter mix.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A food product, comprising:
a bakable batter;
water between:
a minimum of approximately 50%; and
a maximum of approximately 55%;
potassium sorbate; and
sorbic acid;
contained in a sealed pressurized dispenser.

2. The food product of claim 1 wherein the pressurized container contains a dry mix batter combined with water in a ratio of about 50% water to 50% mix.

3. The food product of claim 1 wherein the dispenser is pressurized with carbon dioxide (C02).

4. The food product of claim 3 wherein the dispenser is initially pressurized at 130 pounds per square inch.

5. The food product of claim 4 wherein the absorbed pressure of the C02 in the mix is 86 pounds.

6. The food product of claim 3 wherein the weight of the gas is 5.4 grams.

7. The food product of claim 1 wherein the pressurized container contains a dry mix batter combined with water in a ratio of about 47.5% mix to 52.5% water.

8. The food product of claim 1 wherein the dispenser is pressurized with a combination of gas nitrogen (N2) and C02 mixed gas.

9. The food product of claim 8 wherein the ratio range of Nitrogen to C02 is about 90% nitrogen-10% carbon dioxide to 80% nitrogen-20% carbon dioxide.

10. The food product of claim 9 wherein the weight of the nitrogen is 3.9 grams.

11. The food product of claim 9 wherein the can is initially pressurized to 130 pounds.

12. The food product of claim 9 wherein the absorbed pressure of the gas in the mix is greater than 86 pounds and less than 130 pounds per square inch.

13. The food product of claim 1 wherein the product is shelf stable.

14. A food product, comprising:
a pressurized container;
a bakable batter in the pressurized container including water between:
a minimum of approximately 50%; and
a maximum of approximately 55%;
potassium sorbate;
sorbic acid; and
a pressurized gas comprising at least a portion of carbon dioxide.

15. The food product of claim 14 wherein the dispenser is pressurized with substantially all carbon dioxide (C02).

16. The food product of claim 14 wherein the pressurized container contains a dry mix batter combined with water in a ratio of about 45% mix to 55% water.

17. The food product of claim 14 wherein the dispenser is pressurized with a combination of gas nitrogen (N2) and C02 mixed gas.

18. The food product of claim 17 wherein the ratio range of Nitrogen to C02 is about 90% nitrogen-10% carbon dioxide to 80% nitrogen-20% carbon dioxide.

19. The food product of claim 14 wherein the product is shelf stable.

20. A method for assembling a food product, comprising:
mixing a bakable batter with a fluid; wherein the fluid includes water between:
a minimum of approximately 50%; and
a maximum of approximately 55%;
potassium sorbate; and
sorbic acid;
depositing the bakable batter in a pressure stable container; sealing the container; and pressurizing the container.

21. The food product of claim 20 wherein the pressurizing step is comprising pressurizing at 130 pounds per square inch.

22. The food product of claim 20 wherein the pressurizing step is comprising pressurizing at with Carbon Dioxide.

23. The food product of claim 20 wherein the pressurizing step is comprising pressurizing with a nitrogen and carbon dioxide mix.
